(19) United States
(12) Patent Application Publication
(10) Pub. No.: US 2003/0093334 A1
(43) Pub. Date: May 15, 2003

(54) System and a method for transacting E-commerce utilizing voice-recognition and analysis

(76) Inventor: Ziv Barzilay, Ramat HaSharon (IL)

Correspondence Address: Edward LANGER, c/o Shiboleth, Yisraeli, Roberts, Zisman & Co., 60th Floor, 350 Fifth Avenue, New York, NY, 10118, US

(21) Appl. No.: 10/288,579

(22) Filed: Nov. 6, 2002

Related U.S. Application Data
(60) Provisional application No. 60/331,155, filed on Nov. 9, 2001.

(51) Int. Cl. G06F 17/60

(52) U.S. Cl. 705/26

(57) ABSTRACT

A system for promoting and conducting computerized, E-commerce transactions operated via a wireless network, the system including a mobile, cellular telecommunications device for remote communication; a voice recognition unit for identifying, authenticating, and interfacing with a customer; a central processing unit for processing, managing and implementing the commercial transactions in real time; and at least one customer database for storing a customer's orders, purchasing patterns, and promotional offers matched to the customer.

### FIELD OF THE INVENTION

The present invention generally relates to the field of electronic commerce, and more particularly, to a system and a method for transacting and promoting mobile commerce utilizing voice-recognition and analysis over a wireless, cellular telecommunications network.

### BACKGROUND

It is useful for individuals to be able to control consumer needs and wants from a remote location. Placing orders for goods and services over conventional wire-line telephone networks is quite common. Purchases made from remote locations can even be paid for by providing a seller with credit card information or making other financial arrangements acceptable to both buyer and seller. The introduction of cellular phones and other mobile, hand-held wireless devices has extended the variety and scope of remote transactions from those broadly defined as electronic commerce (E-commerce) transactions using PCs and the Internet, to mobile commerce (M-commerce) transactions, but appropriate business applications for mobile platforms are only recently coming into use and many such applications are still in the developmental stage, limiting wider commercial exploitation of this technology.

New combinations between base applications of a cellular network enable improving the old concepts and procedures for purchasing and selling. Heretofore, dialing a telephone number on a telecommunications device, such as a cellular phone, merely connected a buyer and a seller to directly negotiate or arrange for completion of a business deal, usually for a product or service whose price was known in advance and which both parties agreed to. In some cases, a seller might inform the buyer of special sales, but this was not a regular policy. Payment was usually arranged by credit card, or payment made upon delivery. The remote conduct of business was only an extension of doing business in person without the benefit of seeing the product. The cellular phone in effect became an extension of legacy systems of doing business.

The use of the Internet to promote E-commerce transactions raised the conventional method of doing business to a new level. Now products could be displayed and seen in full color. Multi-media promotion caught on very quickly and sensory appeals lured customers to commercial sites on the Internet where they were presented with appealing options for purchasing a large variety of products, sometimes with discounts and special offers. Payment in this system was also by credit card, and sometimes through the medium of a credit supplier to avoid the risks of transmitting confidential credit information over the Web. Still, the system of doing business was more like buying and selling with a phone and a catalog at your service, but without fully exploiting the advantages of the new technologies coming into use in today's computer-assisted society. Many of today's mobile, hand-held telecommunications devices, such as Personal Digital Assistants (PDAs) and cellular phones, are competing with conventional switched telephone systems (PBXs) for conducting commercial transactions and promoting business, providing more robust business operations with greater flexibility than ever before.

Thus far, the integration of voice and data are well-known features of newer digital PBX systems, but PBXs cannot currently handle the larger bandwidth provided by Local Area Networks (LANs) which operate at much higher data rates. Workstations and PCs are now beginning to solve this problem by turning desktop computers into telephone devices.

Voice-over-IP (VoIP) is gaining in popularity with the growth of the Internet, particularly insofar as making cheap international telephone calls, but the Internet was designed for data traffic transmitted in packets or burst and allowing for delays, which make the Web less than ideal for full voice transmission applications. Voice transmission cannot allow delays and requires far greater bandwidth than data transfer.

Nevertheless, computers are married to telephony applications using such solutions as the Telephone Application Programming Interface (TAPI) developed by the European Computer Manufacturers Association (ECMA) in 1988. It is a method of addressing specific applications such as call centers, data collection and distribution, hotel applications, and the like.

Call centers have automated the task of placing orders by requesting confidential information from callers, such as the caller's phone number, personal identification number (PIN), or secret code number and route the caller to an automated response system. Once there, a caller uses a keypad to enter in ordering information, such as a product code. A database (DB) provides the rest of the information needed to process the order. Billing and shipping information are already stored in the DB and unless modified by the caller, are used to complete the transaction.

Another aspect of the VoIP market is the use of voice mail. This is made possible by using computers provided with a Dual-tone Multi-frequency (DTMF) tone unit allowing both digital data transfer and VoIP transmissions. The DTMF tones identify the mailbox number to be connected to a caller. Software is used to control any number of recordings which provide instructions for leaving a voice message on the voice mail. Messages are stored in digital form on the hard disk of the voice mail system. The voice mail is only partly inter-active and has the disadvantage of being time-consuming since one must listen to instructions and long lists of numbers to find with whom to speak, provided, of course, that that person is within telephone reach. Nevertheless, the advantages of using voice mail for operators of businesses and offices receiving large numbers of calls every day far outweighs any disadvantage or inconvenience to callers.

It should be noted that voice mail has another well-known feature, voice announcers These are usually recorded messages usually broadcast over a phone connection after-hours to provide a caller with a series of announcements, such as hours of operation, phone extension numbers for contacts, alternate store locations, and the like. Automated calling agents allow incoming calls to be forwarded to a series of extension numbers within the voice mailing system and allow a caller to dial up specific messages using a routing table which identifies the short extension number dialed and connects the caller. Call centers are good examples of users of voice announcers and voice mail since they are quite familiar in dealing with large volumes of callers and therefore use these automated systems to manage routing to their agents.

Thus, while there have been prior art attempts to provide a telecommunications network system and a method for promoting and conducting commercial transactions, these usually are done over the Internet with delays in communication and without specific matching to consumer wants and needs. Furthermore, the advantages of the new technologies have not been fully exploited, even using the medium of the Internet. At best the system and method used has been marked by an extension of brick and mortar business practices to the electronic media.

### SUMMARY OF THE INVENTION

Accordingly, it is a broad object of the present invention to overcome the above disadvantages and limitations of the prior art by providing a system and a method for conducting and promoting M-commerce over a mobile telecommunications network that increases profits for sellers while reducing overall costs for goods and services.

Another object of the invention is to enable real-time local and global marketing taking advantage of mobile, cellular telecommunications devices to promote business deals and make special offers, such as discounted merchandise, while ordering by VoIP.

Yet another object of the invention is to provide a method for retailing which reduces costs of goods by eliminating expensive overhead, particularly, the need for both large inventories of goods and large parking facilities. Customers save expensive parking fees while shopping in a more convenient, time-saving, and efficient manner.

It is a further object of the invention to provide a new method for doing business utilizing telecommunication networks without requiring any major or expensive changes in the existing infrastructure, thus advantageously reducing the over-all cost of goods sold. A laptop computer and a PC with a modem, a microphone and speakers can be used with the inventive system for connecting with an appropriate commercial application service. Internet Service Providers (ISPs) as well as cellular service providers (CSPs) can use the invention in their networks much as telephone service providers do. Of course, some CSPs, in order to generate more revenue, also provide Internet service and are thus positioned to take greater advantage of the over-all market.

The present invention uses a voice recognition system which manages the local system, such as located on the premises of a CSP. Alternatively, the inventive system at the local level communicates to a central system, if needed. The customer is identified, then the software program of the system creates an illusion of being in a store with a personal salesman who arranges the order for you, suggests special deals according to the product department and/or the customer's credit standing. The system is optionally configurable to arrange for the delivery of the prepared order, to calculate the billing, and perform various management and control functions, such as automatically adjusting the inventory for a seller or supplier of the product or goods sold to reflect the current status of stock for future orders. In another embodiment of the invention, the system sends billing information online to another selected system.

The inventive system provides an Open System Interface that improves on prior art systems and methods of conducting and promoting E-commerce in general, and M-commerce in particular. This is done in the most convenient and economical way, more flexible and simpler to implement than conventional systems. Indeed, implementation and remote control of the system can be performed via existing communication networks without any major or expensive changes in the equipment or the operational networks. In addition, the system introduces a new attitude of doing commercial business by reducing the over-all cost of goods sold.

These and other needs are met by the system and the method of the present invention wherein the computerized control system is, directly or by central computer, provided and connected to a wireless network, such as a cellular telephone network. The system is configured to operate remotely in ordering goods and services, making voice and/or data negotiate with the remote user, serving and registering his requests, suggesting current deals, and promoting new products. The system is easily updated and management and control functions can be implemented from remote locations using an appropriate user interface, such as a keypad and alphanumeric command codes. The system has designed-in a matter of improving the major factors that are involved in the purchasing world. The new method proposed by this invention creates a comprehensive solution to the world's major commercial problems: how to increase sales, reduce over-all costs, facilitate business opportunities, and ensure control for the responsible manager.

This is an over-all solution providing, on the one hand, profit growth for sellers, but on the other hand, reduction of the price of goods to buyers. This is a phenomenon which permits, in a scientific and proven way, an increase in the sales cycle for businesses for specific goods. New businesses will be able to penetrate the market and accumulate customers more easily. This will broaden employment and production and expand economic developments to peripheral areas not currently serviced due to a lack of a mass market and the consequent lack of retail outlets in these outlying areas. The application of new technologies hence brings commercial opportunities to the buying public living far from urban malls and shopping centers.

Thus there is provided a system for promoting and conducting computerized, E-commerce transactions operated via a wireless network, the system comprising: a mobile, cellular telecommunications device for remote communication with the system; a voice recognition unit for identifying, authenticating, and interfacing with a customer of the system; a central processing unit for processing, managing and implementing the commercial transactions in real time; and at least one customer database for storing a customer's orders, purchasing patterns, and promotional offers matched to a specific customer.

There is further provided a billing application unit for billing the customer; and an auto-management system for preparing computerized orders and for inventory and delivery control.

There is also provided a method for promoting and conducting computerized E-commerce transactions utilizing a mobile, cellular telecommunications device operated over a wireless network, the method comprising the steps of: establishing communication with the system; identifying and authenticating a customer utilizing one of voice recognition/analysis tools and data transfer systems; registering new customers by saving profile data to a customer database; requesting a specific commodity, goods, or service; saving customer requests in the customer database; providing customer-specific promotional offers and deals for commodities, goods, or services based on prior purchase history for the customer; conducting remote negotiations and placing an order for at least one of the commodities, goods, or services; billing said customer; maintaining inventory control by adjusting inventory counts for specific goods in accordance with the quantity of said goods sold; arranging for payment and delivery of said at least one of said commodities, goods, and services; and generating at least one of reports selected from the group management and financial reports, inventory reports, delivery details reports, customer profile reports, reports of new products, and reports of special offers and deals.

The present invention links technological capabilities with consumer needs and wants for people in our time, such as, more effective exploitation of time, reduction of the cost of products, and human comfort and convenience. All in all, consumers will profit, owners of businesses will profit, and producers will also profit because, naturally there will be a growth in the sales of their products. Of course the inventive system provides many advantages to cellular operators who are strategically placed to provide the commercial services needed for conducting M-commerce transactions. Thus, all partners in the commercial loop enjoy the benefits of the inventive system and method.

Reducing the cost of a product is a thing which will permit reducing prices, to enlarge cycles, to increase business expansion by means of full control over inventory. In practice, this invention, by facilitating M-commerce, will merge existing needs and commercial priorities, while increasing the profits of cellular operators.

### BRIEF DESCRIPTION OF THE DRAWINGS

For a better understanding of the invention with regard to the embodiments thereof, reference is made to the accompanying drawings, in which like numerals designate corresponding elements or sections throughout and wherein:

FIG. 1 is a block diagram showing the high level architecture of an embodiment of the system of the present invention;

FIG. 2 is a block diagram showing details of the primary systems of the invention; and

FIGS. 3A and 3B depict an extended flowchart showing an embodiment of the method of the invention in accordance with the principles thereof.

### DETAILED DESCRIPTION OF THE INVENTION

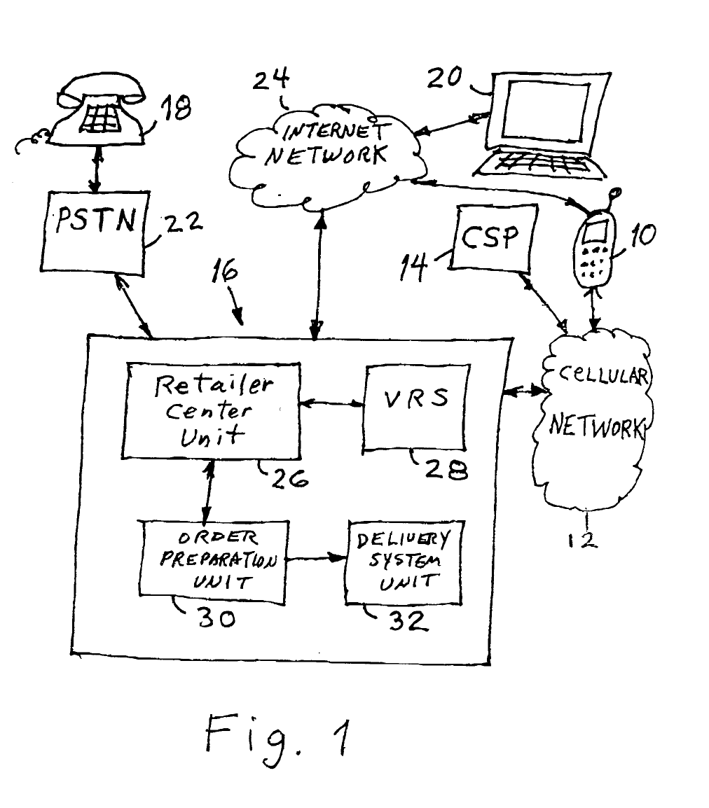

FIG. 1 shows a block diagram of the high level architecture of the present invention in accordance with the principles thereof. Illustrated, in a preferred embodiment of the inventive system, is the use of a cellular phone 10 for access by end users, primarily consumers, to the mobile commercial transaction system (hereinafter called MCTS) 16 of the invention through a cellular network 12, provided by a cellular service provider 14, but other telecommunication devices, such as a standard telephone 18, or a PC 20 connected to a modem, can also be used in conjunction with a wired central telephony network (POTS) 22, or the Internet 24, respectively, to access MCTS 16.

The consumer at cellular phone 10, for example, communicates with a retailing center unit 26 in MCTS 16 by keying in a special, abbreviated telephone number designed for use in a cellular network, or keying in a slightly longer number, if dialing on a standard telephone line, such as from standard telephone 18 or from the modem-enabled PC 20.

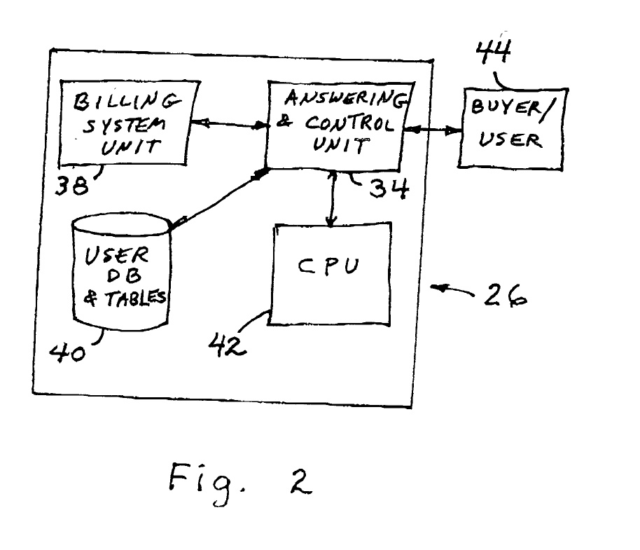

The MCTS 16 responds to a consumer call by activating a voice recognition system 28 to identify the consumer, or requests identifying information if the consumer is a new customer. This information, once provided, is stored in a customer database (see detail in FIG. 2) for use by MCTS 16 for identifying the newly-registered customer in the future, and for promoting and conducting focused business transactions, with the shopping habits and purchase history of the particular customer in mind.

An order preparing unit 30 manages the preparation of customer orders and a delivery system unit 32 manages and controls delivery of merchandise in accordance with the instructions of customers.

FIG. 2 is a block diagram showing details of the primary systems of the invention. The computerized retailer center unit 26 of FIG. 1, comprises an answering and control unit 34 for communicating with callers. The calls directed to MCTS 16 are routed through the answering and control unit 34 which provides a voice synthesizer interface for communicating with consumers, such as customer 36. A voice recognition and/or data transfer system is used to identify the caller. Information on new customers is stored in a database 40 comprising information on all existing buyers, their shopping patterns and preferences, their prior purchase history, and the like. This information is for internal business use by MCTS 16 for the purpose of customer-focused promotion and maximizing the retailing profit while reducing selling and overhead costs. A search is performed in the customer DB 40 and the voice of customer 36 is matched with that stored in DB 40 and with other information related to customer 36. MCTS 16 is thus enabled to provide customer 36 with suggestions for purchasing, current special offers, and discounted merchandise, and the like, based on that information. The MCTS 16 enables customer 36 to know in advance the price of his order since all the deals and special offers, discounts, and the like are taken into account along with the price of the current purchase.

After seeing the order, the MCTS 16 conveys it to the order preparation unit 30 (see FIG. 1), debits the account of customer 36, and prepares the order for handling or delivery in the deliver system unit 32 (see FIG. 1) in accordance with the instructions of customer 36. After completing the negotiations for purchases, the system engages the billing system unit 38 for preparing of bills and for arranging payment for merchandise ordered, generally through the account of the company providing the network service and paid by credit card arrangements through a credit supplier.

MCTS 16, by consulting the customer DB 40, is able to notify the customer 36 when the order will be ready. The customer 36 then either approves of the timetable and acts accordingly, or, optionally, instructs the MCTS 16 to prepare for direct delivery, as the customer 36 chooses. In every case, the organization of deliveries is made strictly in accordance with a customer's instructions. If delivered to the door of customer 36, customer 36 will be charged a fee in accordance with policy. Event processors unit 42 controls the various functions within MCTS 16.

FIG. 2 indicates that the user database 40 also comprises tables. This is an active, permanent memory system. The table data is classified and stores identifying information about each customer registered according to the details entered. The entry time for inputting data is such that output data is almost immediate. The DB 40 is updated on a daily basis and offers customers credit points on various purchases as a further incentive to continue to use the MCTS for future wants and needs.

It should be understood that MCTS 16 is a computerized system based on state-of-the-art off-the-shelf hardware and proprietary software and introduces a new level of service to the buying public. Much time is lost waiting in lines for check-out at retailers, and parking is both expensive and time consuming. The MCTS saves this time and saves consumers money by reducing the cost of merchandise, lowering inventory, reducing promotional expenses, and eliminating the need for large parking lots since customers come to the retailer only when the order is ready, or request direct delivery to door for the added convenience of not having to travel and park at all, to receive their purchased merchandise. This feature also serves the needs of the buying public in remote or peripheral areas who cannot easily get to retail establishments to make their purchases by facilitating transactions using cellular phones as well as other hand-held communication devices instead of traveling by car to make a purchase. Optionally, the system of the invention also arranges for the delivery of goods to complete a transaction.

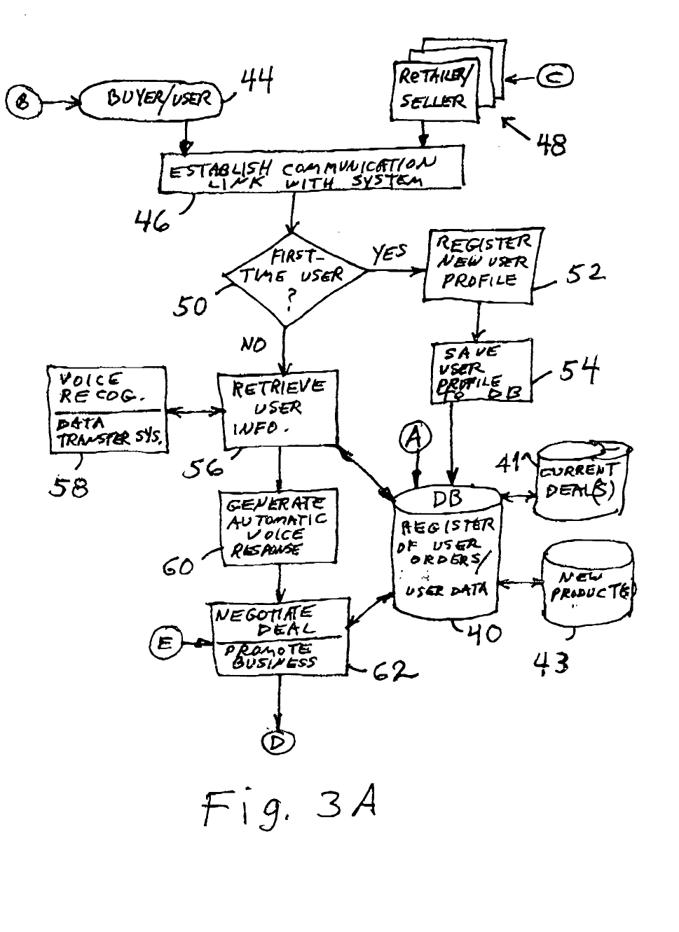

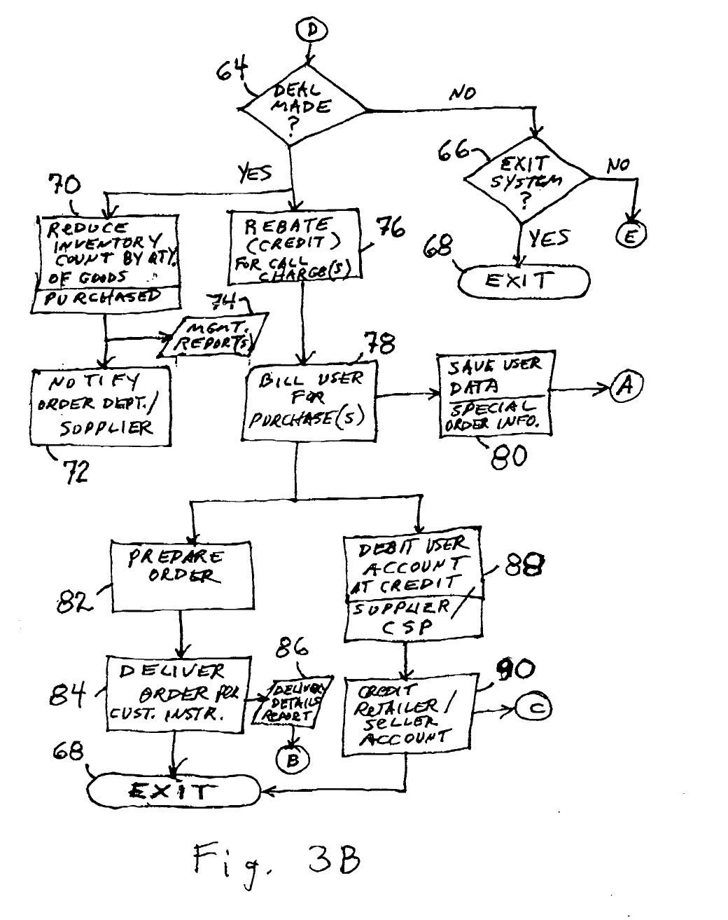

FIGS. 3A and 3B depict an extended flowchart showing an embodiment of the method of the invention in accordance with the principles thereof.

For the purpose of simplicity, and to avoid cluttering the flowchart with long connecting lines, continuity between blocks and other symbols is maintained using a circled capital letter matched appropriately with a counterpart located elsewhere in the flowchart. Link D in FIG. 3A, for example, carries forward the process flow to the next step continued in FIG. 3B, marked with the matching letter D.

In FIG. 3A, a buyer/user 44 dials a phone number to establish a communication link with the system at block 46. The number may be a toll-free number in which case no charge is made for the call. However, regular calls are at the caller's expense unless a purchase is made, in which case the system provides for a rebate of the calling charges when preparing a bill for the customer, as further explained below.

Many retailers/sellers 48 are already subscribers to the system and interconnected through link block 46. The system queries if buyer/user 44 is a first-time user at block 50. If “yes”, the system provides voice instructions to register the new user at box 52 using the advantages of VoIP or voice announcing to make the system as user-friendly as possible. The information provided by buyer/user 44 is saved at box 54 to DB 40 which is a register of user orders referenced to individual users, including their personal data. Other databases made be added to the system, such as DB 42 for storing data regarding current deals and DB 43 for storing data regarding new products which are on the market and for sale through the system retailers/sellers 48.

If the buyer/user 44 is registered in the system at DB 40, the system retrieves the user's information at block 56 using a voice recognition unit/data transfer system at block 58 which compares the voice of the caller with the voice data stored in the VRS DB and downloads and transfers the relevant user data stored in DB 40 for the matching voice data.

When a match is found, the system generates automatic voice responses at block 60 which replicate a human salesman interacting with the requests and orders of buyer/user 44 by utilizing state-of-the-art interactive voice technology. Utilizing the personal data and purchasing history of buyer/user 44, the system can provide very pointed promotions and special offers, saving time and money for both buyer and seller. This negotiations for a deal and promotion of business is made at block 62.

FIG. 3B continues the flow chart of an embodiment of the method of the invention following link D from FIG. 3A.

At block 64, if negotiations for a deal with a potential buyer do not lead to a sale (“NO”), the buyer/user 44 is given the option at block 66 to exit the system. If “YES”, the call is concluded at EXIT block 68 and the buyer/user 44 exits the system. On the other hand, if the caller wishes to continue negotiations for a purchase or deal, at link E, the system recycles the caller to the step at block 62 (FIG. 3A) for further deal-making and for receiving other promotional offers that might be more attractive than the prior ones and thus make a sale.

If a deal is made at block 64 (“YES”), the system automatically processes the terms of the deal by updating the inventory records at block 70. The inventory count is reduced by the quantity of goods purchased and the information is sent to an order department and/or a supplier at block 72. The system enables the option of automatic stock orders going directly to suppliers at block 72 to replenish the inventory as needed and to maintain stock levels at a minimum, thus reducing overhead and the expenses involved in overstocking inventory. Optional management reports 74 are provided by the system for transaction or inventory control. Simultaneously, the system automatically rebates any charges for the call to the buyer/seller 44 at block 76. This sum is credited to the buyer/seller 44 when the bill is made up at block 78. The billing step is followed by a step which saves the information for statistical and promotional purposes at block 80 where the information associated with that particular customer is sent on (link A) to save in the system DB 40 (see FIG. 3A).

Once the billing is handled at block 78, the system prepares the order at block 82, and arranges for delivery (or pick-up) according to a customer's instructions at block 84 and the caller exits the system at block 68. A detailed delivery report is generated at block 86 which informs the buyer/seller 44 of the terms of delivery, address, and the like. The link B indicates that the report is sent to the buyer/seller 44 (see FIG. 3A).

The billing system unit 38 (see FIG. 1) may be located on a seller's premises or sited at the service provider such as the CSP 14 (FIG. 1) In any case, normal bookkeeping procedures are followed so that the system debits the user account maintained with a credit supplier, or CSP 14 as indicated in block 88. Balancing this debit is a credit activity at block 90 which credits retailer/seller 48 (FIG. 3A) for the amount of the purchase, as indicated by link C returning to the successful one of retailer/seller 48, thus completing the commercial transaction.

The retailer can advertise his location for his customers over the network system directly and on a scale much broader than the local market. He can also change his street signs and has the option to advertise his merchandise and special offers to a focused market. The MCTS system is planned and, in accordance with the regular program, and/or immediate demands, is programmed to supply full reports of transactions and other events in the system, over-all, or on each stage of the purchasing process.

Having described the present invention with regard to certain specific embodiments thereof, it is to be understood that the description is not meant as a limitation, since further modifications may now suggest themselves to those skilled in the art, and it is intended to cover such modifications as fall within the scope of the described invention.

I claim:

1. A system for promoting and conducting computerized, E-commerce transactions operated via a wireless network, said system comprising:
a mobile, cellular telecommunications device for remote communication;
a voice recognition unit for identifying, authenticating, and interfacing with a customer;
a central processing unit for processing, managing and implementing said commercial transactions in real time; and
at least one customer database for storing a customer's orders, purchasing patterns, and promotional offers matched to said customer.

2. The system as claimed in claim 1, further comprising:
a data transfer unit for interfacing with said customer;
a billing application unit for billing said customer; and
an auto-management system for preparing computerized orders and for inventory and delivery control

3. A method for promoting and conducting computerized E-commerce transactions utilizing a mobile, cellular telecommunications device operated over a wireless network, said method comprising the steps of:
establishing communication with said system;
identifying and authenticating a customer utilizing at least one of voice recognition/analysis tools and data transfer systems;
registering new customers by profile data saved to a customer database;
receiving requests for at least one of a specific commodity, goods, and service;
saving customer requests in said customer database;
providing customer-specific promotional offers and deals for commodities, goods, or services based on prior purchase history for said customer;
conducting remote negotiations and placing an order for at least one of said commodities, goods, or services;
billing said customer;
maintaining inventory control by adjusting inventory counts for specific goods in accordance with the quantity of said goods sold;
arranging for payment and delivery of said at least one of said commodities, goods, and services; and
generating at least one of reports selected from the group comprising management and financial reports, inventory reports, delivery details reports, customer profile reports, reports of new products, and reports of special offers and deals.
